(19) United States
(12) Patent Application Publication
(10) Pub. No.: US 2006/0020847 A1
(43) Pub. Date: Jan. 26, 2006

(54) Method for performing services in a telecommunication network, and telecommunication network and network nodes for this

(75) Inventors: Karsten Oberle, Mannheim (DE); Marcus Kessler, Stuttgart (DE); Peter Domschitz, Stuttgart (DE); Marco Tomsu, Ditzingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/168,419

(22) Filed: Jun. 29, 2005

(30) Foreign Application Priority Data
Jul. 23, 2004 (EP) 04 017 432.8

(51) Int. Cl. G06F 11/00

(52) U.S. Cl. 714/4

(57) ABSTRACT

The invention relates to a method for performing a service or application in a network environment with network elements, which network environment contains a telecommunication network that has at least two network nodes for performing services or applications, all these nodes being equipped with a common layer for service support, wherein, if a particular network node is not equipped such that it can perform a particular service or application, this network node checks with the help of the service support layer whether another network node can perform this service or application and if the other network node can perform this service or application, the first network node passes on the task of performing this service or application to the other network node, which then performs this service or application, as well as a telecommunication network and network nodes for this.

The invention is based on a priority application EP 04 017 432.8 which is hereby incorporated by reference.

### TECHNICAL FIELD

The invention relates to a method for performing services in a telecommunication network with network elements, which network environment contains a telecommunication network that has at least two network nodes for performing services or applications, all these nodes being equipped with a common layer for service support, a telecommunication network with network nodes for performing services or applications and network nodes of a telecommunication network for performing services or applications, wherein this network node has means of checking whether another network node can perform a particular service or application and for performing services or applications, wherein this network node has means of taking over a task to perform a service or application from another network node.

### BACKGROUND OF THE INVENTION

The so-called Next Generation Networks (NGN) offer the user a rapidly growing wealth of applications and services, such as services for voice telephony, multimedia services or Virtual Private Networks (VPN). In order that these services and applications can be offered flexibly and economically, a clear separation of the services and applications level from the transport level was introduced in the Next Generation Networks architectural concept. The control in this Next Generation Network is taken over by a common, unified and flexible control environment, which combines a large number of services and applications with a large number of transport methods. This architecture enables the network operators to select the appropriate combination of service control software and transport method in each case. Services and applications in turn are provided in separate decentralized nodes in the network.

For a planned introduction of new services and applications, either the software must be upgraded in all network nodes, or the corresponding functional elements in the network, or even all network nodes, must be replaced. However, because of hardware restrictions, an upgrade of the network node software is not always possible. While a replacement of all network nodes is always possible, it is not economic because of the immense costs involved especially during the introductory phase for new services and applications, which naturally presents a major hurdle for the introduction of such new services and applications.

In the U.S. Pat. No. 6,374,362 B1, a method is described in which network nodes can access a central network node, by which means they are able to call up distributed processes that are needed in the execution of particular application programs. While this method means that changes need only be made to the central network nodes when new applications and services are introduced, a central process such as this will also lead to a heavy load on one side of the central network node, and furthermore offers no failure safety at all through redundancy.

The invention is based on the object of remedying the situation described above.

This object is achieved according to the invention with a method for performing services or application in a network environment with network elements, which network environment contains a telecommunication network that has at least two network nodes for performing services or applications, all these nodes being equipped with a common layer for service support, wherein, if a particular network node is not equipped such that it can perform a particular service or application, this network node checks with the help of the service support layer whether another network node can perform this service or application and, if the other network node can perform this service or application, the first network node passes the task of performing this service or application to the other network node, which then performs this service or application, or if a particular network node is not equipped such that it can perform a particular service or application, but has means of installing programs, this network node checks whether it can download the program to execute this service or application from another network element within the network environment, and if possible downloads this program and performs this service or application.

A Telecommunication network with network nodes for performing services or applications, wherein each of these network nodes has means for checking whether another network node can perform a particular service or application, which the network node itself cannot perform, and for passing on the task of performing this service or application to that other network node which can perform this service or application, if the first network node cannot perform this service or application and, network nodes of a telecommunication network for performing services or applications, wherein this network node has means of checking whether another network node can perform a particular service or application, which the network node itself cannot perform, and for passing on the task of performing this service or application to that other network node which can perform this service or application, if the first network node cannot perform this service or application and this network node has means of taking over a task to perform a service or application from another network node.

### SUMMARY OF THE INVENTION

The fundamental concept of the invention is to accomplish an introduction of a new service or application in such a way that the corresponding software only has to be upgraded in one or a few network nodes, or the new software is present only in a newly added network node, but these new services and applications can nonetheless be used by all available network nodes. In this case, we say that the services and applications are available in a virtual pool of all network nodes within a cluster of network nodes. If a network node needs a service or application, but this is not implemented locally in the node, the request is either forwarded to a network node within the cluster, in which this service or application is implemented, or the necessary software for executing the service or application is installed on the network node, if this is programmable. In this manner, all network nodes within a cluster have access to all services and applications that are present within the cluster. By means of software, which can be executed for example in the generally known middleware technology, and which is installed in all network nodes within the cluster, the services and applications implemented in the individual network nodes can be made available in the virtual pool. To the control unit, all network nodes appear similarly equipped with all services and applications that are available in the virtual pool. The detailed description will illustrate exactly how the individual network nodes are provided with the information on which services or applications are implemented in which of the network nodes.

### BRIEF DESCRIPTION OF THE DRAWINGS

Further developments of the invention can be taken from the subclaims and the description that follows. The invention is further explained hereinafter with the help of the accompanying drawing:

FIG. 1 shows an example of a network environment, in which the invention can be implemented.

### DETAILED DESCRIPTION OF PREFERRED EMBODIMENTS

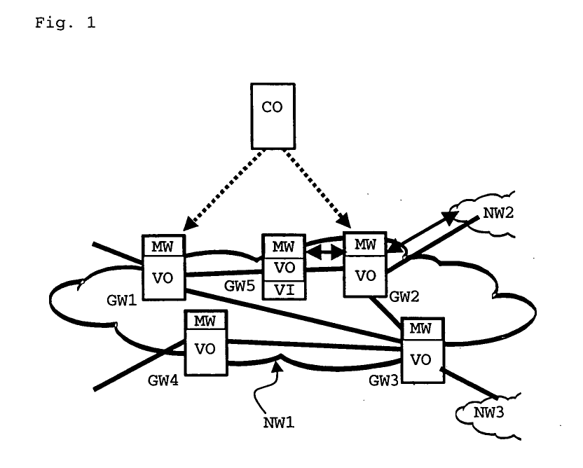

The network environment shown in FIG. 1 contains a cluster of network nodes GW1 to GW5 according to the invention, in a telecommunication network NW1 according to the invention, a control unit CO and as an example two further telecommunication networks NW2 and NW3. The network nodes GW1 to GW5 of the cluster are connected to one another either directly or through network nodes of the cluster, and the network nodes GW1 to GW4 further have connections to other telecommunication networks, of which the two telecommunication networks NW2 and NW3 are shown as examples. The control unit CO is positioned at any point within the network environment, and is connected to all network nodes GW1 to GW5 of the cluster; for greater clarity, only the connections to the network nodes GW1 and GW2 are drawn in.

The telecommunication network NW1 according to the invention consists of any network, for example the Internet or a Local Area Network (LAN), in which additionally the network nodes GW1 to GW5 are also implemented. The network nodes GW1 to GW5 according to the invention can be simple computers, which act for example as web servers for specific services, but also cover special network functions, such as those of a router, switch or gateway. The network nodes GW1 to GW5 further possess means for storing data, such as random access memories (RAMs), hard disks or similar, as well as means for performing service or applications, such as video services. This data can consist of video and/or audio data, such as MPEG data (MPEG=Moving Picture Experts Group) or similar data, but also of program data, such as middleware or a program for coding or decoding data. For the communication within the telecommunication network NW1 and with further telecommunication networks NW2 and NW3, the network nodes GW1 to GW5 have means both for processing and storing data and also for receiving and/or sending it. In the network environment shown as an example in FIG. 1, voice services available nowadays as standard are implemented in all network nodes GW1 to GW5, and labelled as VO. A video service VI is furthermore available in the network node GW5. The implementation of voice and video services in the network nodes GW1 to GW5, as described in the example, serves only to illustrate the invention, and the invention is in no way restricted to these services.

In all network nodes GW1 to GW5 according to the invention, software for service support is implemented, which is executed in middleware technology and referred to in the following text for brevity as middleware MW, by means of which the services and applications can be detected in the cluster and execution of these services and applications is initiated according to the availability and/or load in the different network nodes GW1 to GW5. All network nodes GW1 to GW5 thus have knowledge via the middleware MW of the implementation and location of all services and applications within the cluster. The middleware MW here is generic, i.e. independent of the services and applications that are implemented in the network nodes. Through the middleware MW, each network node GW1 to GW5 has means of checking whether another of the network nodes GW1 to GW5 can perform a particular service or application that the network node itself cannot perform, and of transparently passing to this other network node the task of performing this service or this application for the network nodes GW1 to GW5 and the control unit CO, each network node GW1 to GW5 further also having means of taking over a task to perform a service or application from another of the network nodes GW1 to GW5. The information on which services or applications are implemented in which network nodes GW1 to GW5 can e.g. be stored in data records administered by the middleware MW in the individual network nodes GW1 to GW5. Alternatively, the network nodes GW1 to GW5 can also find out by MW-controlled queries to others of the network nodes GW1 to GW5, whether the desired service or application is implemented in one of the other network nodes, or whether there is information there, possibly according to the distributed list principle, specifying which of the network nodes GW1 to GW5 holds either the implementation of the requested service or application, or information about the storage location of the requested service or application.

In a further embodiment, each network node GW1 to GW5 has means of asking other network elements within the network environment, for example the network nodes GW1 to GW5 or a media server, for programs for executing services and/or applications that are not implemented in the network node, and of installing these programs after receiving them, and running them if necessary.

As shown in FIG. 1, the control of the switching functions and the services and applications in all network nodes GW1 to GW5 is handled centrally in the example in the control unit CO, and is thus separated from the network nodes GW1 to GW5. To execute this task, the control unit CO has means of receiving, sending, storing and editing data such as control protocols. Such a control unit can be e.g. a so-called Softswitch, and e.g. H.248/MEGACO can be used as control protocol between the control unit CO and the network nodes GW1 to GW5. To the control unit, the virtual pool of services and applications appears transparent, i.e. although the control unit controls the execution of the services and applications, the middleware MW implemented in the network nodes GW1 to GW5 independently controls which of the network nodes GW1 to GW5 the services and applications are executed in.

However, the control of the switching functions and the services and applications in the network nodes GW1 to GW5 need not necessarily be through the central control unit CO, but could also be executed decentrally in the individual network nodes GW1 to GW5, for example if the functions of a SIP proxy (SIP=Session Initiation Protocol) were implemented there.

The telecommunication networks NW2 and NW3 that can be reached from the network nodes GW2 and GW3 can represent any communication network both in a mobile version, such as a GSM network (GSM=Global System for Mobile Communication) and in landline form, such as the Internet.

In the method according to the invention, requests to perform a service or application are sent to one of the network nodes GW1 to GW5. If the network node that has received this request is not equipped such that it can perform this service or application, then this network node checks with the help of the middleware MW whether another of the network nodes GW1 to GW5 is able to perform the service or application. To be able to make such checks, all network nodes GW1 to GW5 have a service support layer, which was realized by the implementation of generic middleware MW in all network nodes GW1 to GW5. If another of the network nodes GW1 to GW5 can perform the service or application, the request to perform this service or application is forwarded, transparently for the control unit, from whichever of the network nodes GW1 to GW5 originally received this request, to this other network node, and this other network node then performs the service or application.

This method according to the invention is shown in an example in FIG. 1. The double arrow between the telecommunication network NW2 and the network node GW2 symbolises the request to the network node GW2 to perform a video service VI. As only the voice services labelled as VO are implemented in the network node GW2, the network node GW2 checks with the middleware MW which of the other network nodes GW1, GW3, GW4 or GW5 is able to perform the desired video service, and finds out that the desired video service, labelled VI, is available in the network node GW5. The network node GW2 thereupon forwards the request for this video service VI to the network node GW5, this action being symbolized by the double arrow between the network nodes GW2 and GW5. The network node GW5 then performs the video service VI and sends the prepared data over the network node GW2 to the telecommunication network NW2. This operation is represented in FIG. 1 by the previously mentioned double arrows between the telecommunication network NW2 and the network node GW2, and between the network node GW2 and the network node GW5. In the general case, a request for a service or application can be made from any telecommunication network NW1 to NW3, and the prepared data after execution of the service or application can be forwarded to any telecommunication network NW1 to NW3.

In a further embodiment of the method according to the invention, the network node which belongs to the group GW1 to GW5 and which has received a request to perform a service or application and is not equipped such that it can perform this service or application, but has means of installing programs, can check whether it can download from another network element within the network environment, e.g. one of the network nodes GW1 to GW5, the program to execute the service or application. If this should be possible, the network node downloads this program transparently for the control unit, and performs the desired service or application.

1. A method for performing a service or application in a network environment with network elements, which network environment contains a telecommunication network that has at least two network nodes for performing services or applications, all these nodes being equipped with a common layer for service support, wherein, if a particular network node is not equipped such that it can perform a particular service or application, this network node checks with the help of the service support layer whether another network node can perform this service or application and, if the other network node can perform this service or application, the first network node passes the task of performing this service or application to the other network node, which then performs this service or application, or if a particular network node is not equipped such that it can perform a particular service or application, but has means of installing programs, this network node checks whether it can download the program to execute this service or application from another network element within the network environment, and if possible downloads this program and performs this service or application.

2. Telecommunication network with network nodes for performing services or applications, wherein each of these network nodes has means for checking whether another network node can perform a particular service or application, which the network node itself cannot perform, and for passing on the task of performing this service or application to that other network node which can perform this service or application, if the first network node cannot perform this service or application.

3. Telecommunication network according to claim 2, wherein one or more of these network nodes have means of checking whether they can download from another network element within a network environment, which contains the telecommunication network, a program to execute a service or application which they cannot themselves perform, in order to download this program and to perform this service or application.

4. Network node of a telecommunication network for performing services or applications, wherein this network node has means of checking whether another network node can perform a particular service or application, which the network node itself cannot perform, and for passing on the task of performing this service or application to that other network node which can perform this service or application, if the first network node cannot perform this service or application.

5. Network node of a telecommunication network for performing services or applications, wherein this network node has means of taking over a task to perform a service or application from another network node.

6. Network node according to claim 4, wherein this network node has means of checking whether it can download from another network element within a network environment, which contains the telecommunication network, a program to execute a service or application which this network node itself cannot perform, in order to download this program and to perform this service or application.
